(19) United States
(12) Patent Application Publication
(10) Pub. No.: US 2014/0265296 A1
(43) Pub. Date: Sep. 18, 2014

(54) Bookmark

(71) Applicant: Matthew Thompson, Bothell, WA (US)

(72) Inventor: Matthew Thompson, Bothell, WA (US)

(21) Appl. No.: 13/838,174

(22) Filed: Mar. 15, 2013

(51) Int. Cl. B42D 9/00

(52) U.S. Cl. CPC B42D 9/004
USPC 281/42

(57) ABSTRACT

Disclosed is, among other things, a bookmark including a band which may wrap around a book and may therefore be prevented from falling out as the book is opened. A marker may be attached to the band via a thread or other means, and may be used to mark a page of interest in the book.

### FIELD

This disclosure relates to bookmarks.

### BACKGROUND

Keeping track of a place in a book may be done in many ways. Bending corners of pages, placing slips of paper or cardboard between pages, and ribbons attached to covers have all been used to remember a reader's position.

But it is easy to lose paper or cardboard bookmarks, and they sometimes slip out causing a reader to lose the place of interest in a book. Most books do not have attached ribbons, and many people do not like bending pages, especially if books are borrowed.

### SUMMARY

The instant application discloses, among other things, a bookmark that allows a reader to securely fasten a bookmark to a book, while easily removing it to use in another book.

In one embodiment, a band may have adjustable beads at one end. The band may be placed with one side on the edge of the book and another side somewhere near the middle of the book. The beads may then be used to tighten the band so that it may not easily fall from the book. A crimped bead may provide extra tension to prevent the beads from moving loosely on the band. A charm or similar marker may be attached via a thread to the loop near the top of the book, and the marker may be used as a page marker. This may prevent the bookmark from getting lost, and may allow for a reader to have flexibility in a selection of colors, materials, and size and shape of the marker.

### BRIEF DESCRIPTION OF THE DRAWINGS

FIG. 1 is a drawing of one embodiment of a Bookmark.

FIG. 2 illustrates one embodiment of a Bookmark as it may be used.

FIG. 3 illustrates another embodiment of a Bookmark as it may be used.

Like reference numerals indicate like elements in the drawings. Elements in the drawings are not drawn to scale unless otherwise indicated.

### DESCRIPTION

A more particular description of certain embodiments of a Bookmark may be had by references to the embodiments shown in the drawings which form a part of this specification, in which like numerals represent like objects.

FIG. 1 is a drawing of one embodiment of a Bookmark. In this embodiment, Band 110 may be a ribbon, tied with Knot 140 to form a loop. In this embodiment, a ribbon may be a flat or tubular narrow fabric (as of silk, rayon, nylon, or cotton), and may be closely woven in various constructions (as in velvet, satin, taffeta, or grosgrain).

In another embodiment Band 110 may be replaced by a steel loop with an adjusting nut, slider, or other device to enable a snug fit. In yet another embodiment, Band 110 may be made of leather. In yet another embodiment, Band 110 may be made from plastic. In yet another embodiment, Band 110 may be made of a combination of materials, twisted around one another. In yet another embodiment, Band 110 may be made of a plurality of materials connected end to end. One having skill in the art will recognize that Band 110 may be made from a number of different materials, or combinations of materials.

Band 110 may be placed over a book, and Crimped Bead 130 may be moved against Bead 120, which may hold Band 110 snugly against the book. Knot 140 may prevent Crimped Bead 130 from slipping off Band 110. In other embodiments other ways of tightening Band 110 to a book may be used. In one embodiment, a drawstring clip may be used to tighten Band 110. In another embodiment, a nut may be screwed on an end of a metal or plastic band to allow for tightening.

Bead 120, 125 may comprise one or more beads, which may be decorative in addition to providing a way to tighten Band 110. One having skill in the art will recognize that various sizes, colors, materials, and quantities may be used for Bead 120, 125, which may allow for aesthetic enhancement.

Marker 150 may be a piece of material, such as metal, plastic, carbon fiber, wood, or other material that may be placed between pages of a book to mark a location.

Marker 150 may be attached to Band 110 by Thread 160. One skilled in the art will recognize many different means may be used to attach Marker 150 to a Band 110, including but not limited to thread, ribbon, string, leather, plastic, wire, a pivoting device, a ball joint, or other materials or devices.

FIG. 2 illustrates one embodiment of a Bookmark as it may be used. Band 110 may be placed over a book, forming a loop over a cover or one or more pages. Bead 120 and Crimped Bead 130 may be adjusted to provide a snug fit over the book, which may hold Band 110 in place. Thread 160 may attach Marker 150 to Band 110 so that Marker 150 may be kept with Book 210 and may not fall when Book 210 is opened to a page marked by Marker 150. In this example, Marker 150 is shown on the same page as Band 110, but it may be used to mark any page in Book 210. Marker 150 may be thin and approximately flat, which may prevent damage to Book 210, such as damage to a binding or pages in the Book 210.

In another embodiment, Thread 160 may extend past the bottom of Book 210, which may allow Marker 150 to be held outside the Book 210, which may allow Marker 150 to be thicker than if it is held in Book 210.

FIG. 3 illustrates another embodiment of a Bookmark as it may be used. In this embodiment, Band 240 may be made of plastic or metal, and may be configured as two strips coupled at the top; for example it may comprise a small tube with a slit running from a bottom for most of the length toward a top, or it may comprise two flat strips with a hinge at a top. It may have a small rubber band encircling the two strips near the bottom, or there may be a Nut 220 which fits Thread 230 which may hold both strips together on the bottom and may allow for an adjustment to keep Band 240 snug on Book 210. Beads or other decorative means may be placed on Band 240 or Band 240 may be colored, textured, or otherwise customized for aesthetic enhancement.

One having skill in the art will recognize that many different types of material and designs may be used for Band 240, and many different types of fasteners and adjustment means may be used for coupling Band 240 on the bottom.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A bookmark, comprising:
a band capable of being placed over an open book, the band comprising a loop;
a means for adjusting the loop to fit snugly against the book;
a marker; and
a coupling means coupling the marker to the band, allowing the marker to be placed near a page of the book.

2. The bookmark of claim 1, wherein the means for adjusting the loop comprises a crimped bead.

3. The bookmark of claim 1, wherein the means for adjusting the loop comprises a nut.

4. The bookmark of claim 1, wherein the means for adjusting the loop comprises a drawstring clamp.

5. The bookmark of claim 1 wherein the band comprises a material selected from the group consisting of ribbon, yarn, natural or synthetic rubber, thread, string, leather, plastic, metal, and carbon fiber.

6. The bookmark of claim 1, wherein coupling comprises a thread.

7. The bookmark of claim 1, wherein the coupling comprises a material selected from the group consisting of ribbon, yarn, natural or synthetic rubber, thread, string, leather, plastic, metal, and carbon fiber.

8. The bookmark of claim 1, wherein the coupling comprises a device selected from the group consisting of a pivoting device and a ball joint.

9. The bookmark of claim 1, wherein the band comprises a ribbon.

10. The bookmark of claim 9, wherein the means for adjusting the loop comprises a crimped bead.

11. A bookmark, comprising:
a ribbon sized to be placed over an open book, the ribbon comprising a loop;
a crimped bead for adjusting the ribbon to fit snugly against the book; and
a marker coupled to the loop via a thread, allowing the marker to be placed near a page of the book.
